(19) United States
(12) Patent Application Publication
(10) Pub. No.: US 2016/0356979 A1
(43) Pub. Date: Dec. 8, 2016

(54) TRANSPARENT PROTECTION COVER AND DISPLAYING APPARATUS

(71) Applicant: SHENZHEN CHINA STAR OPTOELECTRONICS TECHNOLOGY CO., LTD., Shenzhen, Guangdong (CN)

(72) Inventor: Yanxue ZHANG, Shenzhen, Guangdong (CN)

(73) Assignee: Shenzhen China Star Optoelectronics Technology Co., Ltd., Shenzhen, Guangdong (CN)

(21) Appl. No.: 14/414,101

(22) PCT Filed: Dec. 27, 2014
(86) PCT No.: PCT/CN2014/095221

§ 371 Date: Jan. 10, 2015

(30) Foreign Application Priority Data
Dec. 9, 2014 (CN) 201410751074.9

(51) Int. Cl. G02B 7/02; G02F 1/1335

(52) U.S. Cl. CPC G02B 7/02; G02F 1/133526

(57) ABSTRACT

A transparent protection cover is provided for use on a display screen of a display device. The transparent protection cover includes an edge frame and a body. The edge frame is formed along an edge of the body. The edge frame is coupleable to the display device. The body is disposed on an external surface of the display screen of the display device. The body is in the form of a concave lens. Besides protecting the display screen of the display device, the transparent protection cover also helps alleviate damage to the eyesight of a user in using the display device. A display apparatus is also provided.

### CROSS REFERENCE TO RELATED APPLICATIONS

This application claims the priority of Chinese Patent Application No. 201410751074.9, entitled “Transparent Protection Cover and Displaying Apparatus”, filed on Dec. 9, 2014, the disclosure of which is incorporated herein by reference in its entirety.

### BACKGROUND OF THE INVENTION

1. Field of the Invention

The present invention relates to the field of liquid crystal displaying technology, and in particular to a transparent protection cover for mounting to a display screen.

2. The Related Arts

With the increasing expansion of the applications of mobile communication devices, thanks to the progress of liquid crystal displaying technology, reading electronic documents is gradually taking the place of reading paper printing. However, a user using a liquid crystal product for a long time would inevitably impair the eyesight of the user in a more severe manner, particularly for people suffering nearsightedness but not wearing eyeglasses.

### SUMMARY OF THE INVENTION

The technical issue to be addressed by the present invention is to provide a transparent protection cover that is mounted to a display screen to protect the display screen of a display device and also to reduce damage to the eyesight of a user in using the display device.

To achieve the above object, the present invention provides the following technical solutions:

The present invention provides a transparent protection cover for use on a display screen of a display device. The transparent protection cover comprises an edge frame and a body. The edge frame is formed along an edge of the body. The edge frame is coupleable to the display device. The body is disposed on an external surface of the display screen of the display device. The body is in the form of a concave lens.

In the above structure, the edge frame and the display device are coupled to each other through a snap fastening structure.

In the above structure, the edge frame comprises a magnetic strip attached thereto and the display device has a side wall that is coupled to the edge frame through magnetic attraction.

In the above structure, the body comprises an external surface and an internal surface. The internal surface faces the display screen of the display device and the external surface faces away from the display screen. The external surface is in the form of a concave curved surface and the internal surface is of a planar form.

In the above structure, the body comprises an external surface and an internal surface. The internal surface faces the display screen of the display device and the external surface faces away from the display screen. The external surface is in the form of a concave curved surface and the internal surface is also in the form of a concave curved surface.

In the above structure, the body comprises an external surface and an internal surface. The internal surface faces the display screen of the display device and the external surface faces away from the display screen. The external surface is in the form of a convex curved surface and the internal surface is in the form of a concave curved surface.

The present invention also provides a displaying apparatus, which comprises a display device and a transparent protection cover. The transparent protection cover is disposed on a display screen of the display device. The transparent protection cover comprises an edge frame and a body. The edge frame is formed along an edge of the body. The edge frame is coupleable to the display device. The body is disposed on an external surface of the display screen of the display device. The body is in the form of a concave lens.

In the above structure, the body comprises an external surface and an internal surface. The internal surface faces the display screen of the display device and the external surface faces away from the display screen. The external surface is in the form of a concave curved surface and the internal surface is of a planar form.

In the above structure, the body comprises an external surface and an internal surface. The internal surface faces the display screen of the display device and the external surface faces away from the display screen. The external surface is in the form of a concave curved surface and the internal surface is also in the form of a concave curved surface.

In the above structure, the body comprises an external surface and an internal surface. The internal surface faces the display screen of the display device and the external surface faces away from the display screen. The external surface is in the form of a convex curved surface and the internal surface is in the form of a concave curved surface.

The present invention is structured to make the body in the form of a concave lens so that, besides protecting the display screen of the display device, the transparent protection cover also helps alleviate damage to the eyesight of a user in using the display device, because the concave lens of the body allows a user having poor eyesight to use the display device in a clear viewing way so as to reduce tiredness of eyesight.

### BRIEF DESCRIPTION OF THE DRAWINGS

To more clearly explain the technical solution proposed in the present invention, a brief description of the drawings that are necessary for embodiments is given as follows. It is obvious that the drawings that will be described below show only some embodiments of the present invention. For those having ordinary skills of the art, other drawings may also be readily available from these attached drawings without the expense of creative effort and endeavor.

FIG. 1 is a cross-sectional view showing a transparent protection cover mounted to a display device according to a preferred embodiment of the present invention;

FIG. 2 is a schematic view illustrating coupling between a frame of the transparent protection cover and a display device;

FIG. 3 is a schematic view illustrating a first illustrative embodiment of the transparent protection cover according to the present invention;

FIG. 4 is a schematic view illustrating a second illustrative embodiment of the transparent protection cover according to the present invention; and

FIG. 5 is a schematic view illustrating a third illustrative embodiment of the transparent protection cover according to the present invention.

### DETAILED DESCRIPTION OF THE PREFERRED EMBODIMENTS

A clear and complete description will be given to a technical solution of embodiments of the present invention with reference to the attached drawings of the embodiments of the present invention.

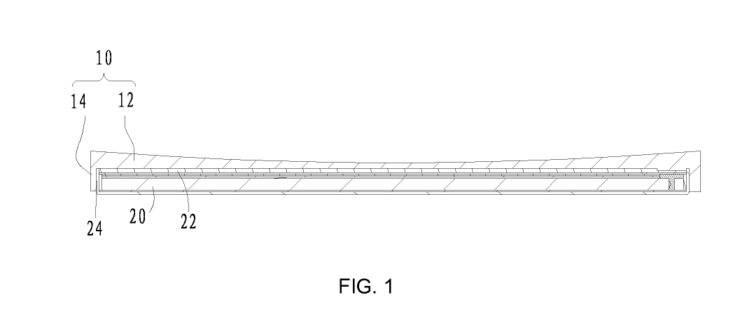

The present invention provides a transparent protection cover 10 for use on a display screen 22 of a display device 20. Referring to FIG. 1, FIG. 1 is a cross-sectional view showing the transparent protection cover 10 mounted to the display device 20 according to a preferred embodiment of the present invention.

The transparent protection cover 10 comprises an edge frame 14 and a body 12. The edge frame 14 is formed along an edge of the body 12. In an embodiment, the edge frame 14 is a frame of a closed rectangular configuration enclosing the body 12. In an embodiment, the edge frame 14 comprises sections respectively set on two opposite side edges of the body 12 in a symmetric manner. The edge frame 14 functions for fixedly coupling to the display device 20. The body 12 is disposable on an external surface of the display screen 22 of the display device 20 and the body 12 is in the form of a concave lens. The body 12 forms a protection layer on the external surface of the display screen 22.

The present invention is structured to make the body 12 in the form of a concave lens so that, besides protecting the display screen 22 of the display device 20, the transparent protection cover 10 also helps alleviate damage to the eyesight of a user in using the display device 20, because the concave lens of the body 12 allows a user having poor eyesight to use the display device 20 in a clear viewing way so as to reduce tiredness of eyesight.

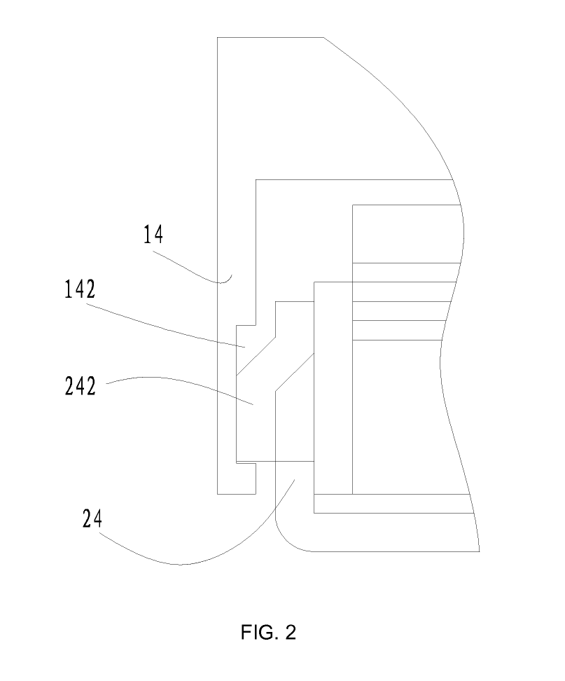

FIG. 2 illustrates one way of coupling between the edge frame 14 and the display device 20. The edge frame 14 and the display device 20 are securely coupled together with a snap fastening structure. The edge frame 14 has a side surface facing the display device 20 and provided with a recessed groove 142 formed therein. The display device 20 has a side wall 24 having an external surface that is provided with a projection block 242. To assemble, the edge frame 14 is first deformed and then the projection block 242 is allowed to snap into the recessed groove 142 to achieve a snap fastening structure.

In another embodiment, magnetism is applied to attach the transparent protection cover 10 to the display device 20. The edge frame 14 comprises a magnetic strip mounted thereto and the side wall 24 of the display device 20 and the edge frame 14 are attached to and coupled with each other through magnetic attraction. This embodiment can be simply achieved by selecting a material of the edge frame 14 of the display device 20 to be interacting with the magnetic strip.

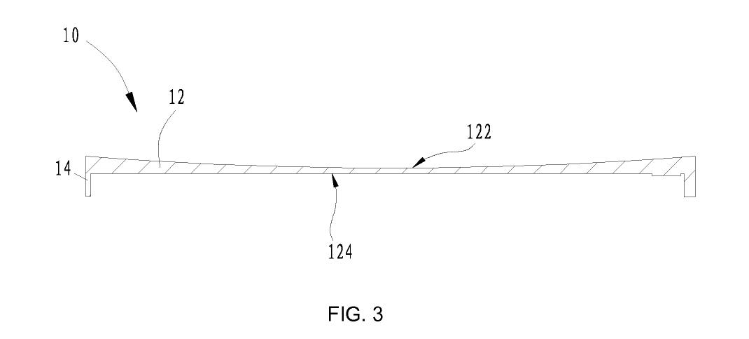

Referring to FIG. 3, which illustrates a first illustrative embodiment of the transparent protection cover 10. The body 12 comprises an external surface 122 and an internal surface 124. The internal surface 124 is set to face the display screen 22 of the display device 20 and the external surface 122 faces away from the display screen 22. The external surface 122 is in the form of a concave curved surface, while the internal surface 124 is of a planar form. In the instant embodiment, after the transparent protection cover 10 is mounted to the display device 20, the internal surface 124 of the body 12 is positioned against the display screen 22 to help reduce the thickness of the display device 20 and thus facilitates thinning of the display device 20.

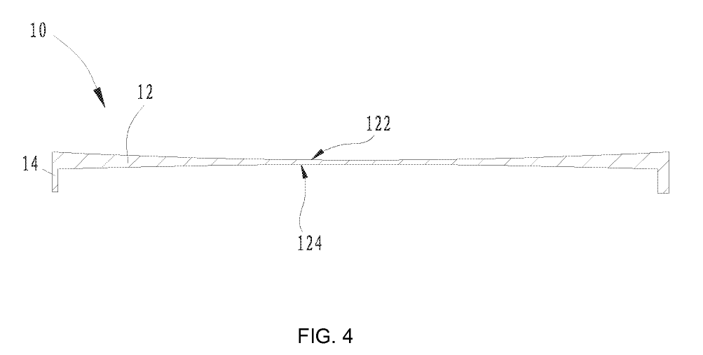

Referring to FIG. 4, which illustrates a second illustrative embodiment of the transparent protection cover 10, the body 12 comprises an external surface 122 and an internal surface 124. The internal surface 124 is set to face the display screen 22 of the display device 20 and the external surface 122 faces away from the display screen 22. The external surface 122 is of the form of a concave curved surface and the internal surface 124 is also in the form of a concave curved surface. In the instant embodiment, both the internal surface 124 and the external surface 122 of the body 12 are structured as concave curved surfaces so that the thickness of a middle portion of the body 12 is less than a thickness of a circumferential edge thereof. The internal surface 124 of the body 12 forms an arched space the display device 20 with respect to the display screen 22.

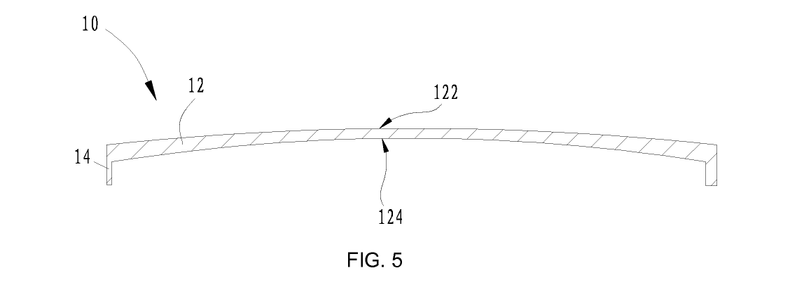

Referring to FIG. 5, which illustrates a third illustrative embodiment of the transparent protection cover 10, the body 12 comprises an external surface 122 and an internal surface 124. The internal surface 124 is set to face the display screen 22 of the display device 20 and the external surface 122 faces away from the display screen 22. The external surface 122 is made in the for of a convex curved surface, while the internal surface 124 is in the form of a concave curved surface.

FIGS. 3-5 show three illustrative embodiments of the transparent protection cover 10, which are usable for people having different eyesight conditions. Each of these illustrative embodiments can be made in such a way that the curvature of the concave curved surface of the concave lens of the body 12 can be of various forms, so that the transparent protection cover 10 is structured to resemble different effects achieved with different diopters of eyeglasses. Since the transparent protection cover 10 according to the present invention is an externally attachable arrangement, the coupling between the transparent protection cover 10 and the display device 20 is detachable and is easy to separate for both the snap fastening structure of the magnetic strip involved structure, both being easy to assemble and disassemble. Users may select a proper transparent protection cover 10 according to the eyesight conditions thereof to alleviate visual tiredness and protect eyesight and also to protect the display screen 22.

The present invention also provides a displaying apparatus, which comprises the display device 20 and the above-discussed transparent protection cover 10 with the transparent protection cover 10 attached to and positioned on the display screen 22 of the display device 20.

The above illustrates the preferred embodiments according to the present invention. However, it is noted that those skilled in the art would appreciate that various improvements and modifications are still available without departing from the scope of the present invention and such improvements and modifications are considered within the scope of protection of the present invention.

What is claimed is:

1. A transparent protection cover for use on a display screen of a display device, wherein the transparent protection cover comprises an edge frame and a body, the edge frame being formed along an edge of the body, the edge frame being coupleable to the display device, the body being disposed on an external surface of the display screen of the display device, the body being in the form of a concave lens.

2. The transparent protection cover as claimed in claim 1, wherein the edge frame and the display device are coupled to each other through a snap fastening structure.

3. The transparent protection cover as claimed in claim 1, wherein the edge frame comprises a magnetic strip attached thereto and the display device has a side wall that is coupled to the edge frame through magnetic attraction.

4. The transparent protection cover as claimed in claim 1, wherein the body comprises an external surface and an internal surface, the internal surface facing the display screen of the display device, the external surface facing away from the display screen, the external surface being in the form of a concave curved surface, the internal surface being of a planar form.

5. The transparent protection cover as claimed in claim 1, wherein the body comprises an external surface and an internal surface, the internal surface facing the display screen of the display device, the external surface facing away from the display screen, the external surface being in the form of a concave curved surface, the internal surface being also in the form of a concave curved surface.

6. The transparent protection cover as claimed in claim 1, wherein the body comprises an external surface and an internal surface, the internal surface facing the display screen of the display device, the external surface facing away from the display screen, the external surface being in the form of a convex curved surface, the internal surface being in the form of a concave curved surface.

7. A displaying apparatus, comprising a display device and a transparent protection cover, the transparent protection cover being disposed on a display screen of the display device, wherein the transparent protection cover comprises an edge frame and a body, the edge frame being formed along an edge of the body, the edge frame being coupleable to the display device, the body being disposed on an external surface of the display screen of the display device, the body being in the form of a concave lens.

8. The displaying apparatus as claimed in claim 7, wherein the body comprises an external surface and an internal surface, the internal surface facing the display screen of the display device, the external surface facing away from the display screen, the external surface being in the form of a concave curved surface, the internal surface being of a planar form.

9. The displaying apparatus as claimed in claim 7, wherein the body comprises an external surface and an internal surface, the internal surface facing the display screen of the display device, the external surface facing away from the display screen, the external surface being in the form of a concave curved surface, the internal surface being also in the form of a concave curved surface.

10. The displaying apparatus as claimed in claim 7, wherein the body comprises an external surface and an internal surface, the internal surface facing the display screen of the display device, the external surface facing away from the display screen, the external surface being in the form of a convex curved surface, the internal surface being in the form of a concave curved surface.
